(19) United States
(12) Patent Application Publication
(10) Pub. No.: US 2010/0313456 A1
(43) Pub. Date: Dec. 16, 2010

(54) SAFE OPERATIVE SURGERY TAG IDENTIFICATION CARD SYSTEM

(76) Inventor: Edward A. Kent, Wakefield, RI (US)

Correspondence Address: BARLOW, JOSEPHS & HOLMES, LTD., 101 DYER STREET, 5TH FLOOR, PROVIDENCE, RI, 02903, US

(21) Appl. No.: 12/485,526

(22) Filed: Jun. 16, 2009

(51) Int. Cl. G09F 3/00; G09F 3/14

(52) U.S. Cl. 40/633; 40/299.01; 40/662

(57) ABSTRACT

A tag identification card system is provided that implements a uniform standard for medical or surgical procedures. The system allows patients to elevate their own safety standards, by requiring surgery staff to follow the World Health Organization “Surgical Safety Checklist”. This invention consists of a synthetic tag identification card upon which is recorded vital patient information. The tag identification card is completed by the patient and physician at the time of consent for procedure. A non-toxic indelible marker is used and the data is covered with a clear coat. The tag identification card is then attached to the patient pre-procedure. This invention will help reduce the risks of wrong site surgery, wrong side surgery, wrong patient surgery, and improve patient safety. Further the system requires that operating room staff sign the tag identification card following each completed safety check.

### BACKGROUND OF THE INVENTION

The present invention relates generally to a tag identification card system that implements a uniform standard for medical or surgical procedures. More specifically, the present invention is related to a synthetic tag identification card upon which is recorded vital patient information that is completed by the patient and physician at the time of consent for procedure and then attached to the patient pre-procedure in order to reduce the risks of wrong site surgery, wrong side surgery, wrong patient surgery, and improve patient safety.

Many mishaps regarding patient identification, type and site of surgery or procedure occur in hospitals. A standardized system to ensure proper patient and procedure identification would be of great benefit and in the Publics' best interest. To date, nobody had implemented any system that is fail-safe. Operative Teams are under stress to work more efficiently and get cases completed expeditiously. Not everyone pays attention during the “time-out” as they are busy inducing anesthesia to patients, completing clerical work or helping the Operating Room (OR) Technician or Scrub Nurse prepare for surgery. Sounds echo off the walls, monitors beep and instruments clang while the Operative Team is trying to listen and watch patient vital signs on monitors. As a result, an operative suite is a very difficult place to concentrate. Further, it is a difficult place to coordinate the surgeon, the anesthesiologist/nurse anesthetist/anesthesia assistant, the OR Circulating Nurse and the OR Technician, to concurrently perform a “time-out”.

Many publications in the medical field have published articles stating what most physicians already knew, health care in the US is not as safe as it should be and can be. At least 44,000 people, and perhaps as many as 98,000 people, die in hospitals each year as a result of medical errors that could have been prevented, according to estimates from two major studies.

Wrong-site surgery is a persistent problem in American health care, despite years of efforts to combat it. Clearly, no patient wants to have the wrong procedure and the health card industry needs to do whatever it can to prevent that. While the non-profit Joint Commission on Accreditation of Health Care Organizations implemented the Universal Protocol during 2004, the problem has continued to get worse. During 2005, health care facilities reported 84 operations to the commission that involved the wrong body part or the wrong patient. Hospitals in Pennsylvania experienced no improvement following the implementation of the Joint Commissions Universal Protocol Standard from March 2004 until March 2006 and the number of errors actually increased. Implementing a Wrong Site Surgery Advisory also resulted in more errors in those institutions that made more safety checks.

Dr. Jodi Gerdes and colleagues during 2008 demonstrated that, trauma surgery residents and surgeons make twice as many cognitive errors in simulations tests after a night of being on-call as compared to the beginning of their shift. Dr. Gerdes believes that even a small amount of reported fatigue in attending surgeons can actually lead to a significant amount of errors.

The World Health Organization (WHO) “Surgical Safety Checklist” launched under Safe Surgery Saves Lives initiative, June 2008, hopes to address many operative patient issues. WHO stipulates that a Sign-In includes potential airway issues and anticipated blood loss. A Time-Out encompasses patient and procedure identification, critical events, anesthesia concerns, allergies and antibiotic use. A Sign-Out includes procedure, instrument and sponge counts, specimens and intra-operative problems encountered, all of which is to be communicated to the Post Anesthesia Care Team or Recovery Room staff. In this context, WHO has attempted to address the difficult task surrounding surgical patient identification, site and side of surgery and pre-intra-and post operative patient status. Such standards are created by the WHO, the Joint Commission, Medical Boards, Departments of Health, hospitals and various institutions. These standards are well intended to help ensure patent safety, however, they are usually implemented in response to an event or a poor patient outcome. By the time the standards are invariably implemented, it tends to be on a variable basis and tend to be less carefully followed as time progresses. The “time out” is still inconsistently applied depending on the institution and diligence of the staff members at the time at which surgery is performed.

The WHO Surgical Safety Checklist clinical trials were applied to 3,733 consecutive patients in multinational hospitals. The death rate was reduced to 0.8% from 1.5% and the complication rate was reduced to 7% from 11%. Implementation of the checklist was associated with concomitant reductions in the rates of death and complications among patients at least 16 years of age who were undergoing non-cardiac surgery in a diverse group of hospitals. This demonstrates that a checklist works.

Accordingly, there is a need for a system that will help to improve perioperative patient safety and reduce iatrogenic wrongful harm to patients who expect to be cared for properly and safely. There is a further need for a Tag ID Card to complete that is attached to the patient, which forces the team to comply with the patient's request by requiring that they verify the card data and implement a Surgical Safety Checklist prior to the procedure. There is a further need for a system to ensure that the correct patient has the correct side and site surgery.

### BRIEF SUMMARY OF THE INVENTION

Patients usually have a colored plastic Hospital Identification card created by an addressograph. This contains the patient's name, date of admission, date of birth, sometimes social security number, surgeon, medical record number and hospital number. This card normally does not list allergies, procedure, or site or side of surgery. Accordingly, the present invention provides a Tag ID Card made of non-irritating synthetic material that shall be utilized pre-operative or pre-procedure. This Tag ID Card shall record vital patient information that shall be physically attached to the patient prior to entering the hospital or procedure facility. The card shall be attached to the patient's extremity, preferentially on the same side as the intended surgery. Preferably the card shall be formed of a non-pyogenic, non-irritating material and include two straps to secure the Tag Identification Card to the patient, preferably on their arm or leg. A permanent marking will be made thereon for patient and procedure data and a clear coat marker will be used to overwrite and protect the scribed data.

This Tag ID Card shall preferably contain the following information that is lightly printed or embedded on the Tag ID Card:

```
Front:
    Name:
    Date of Birth:
    Physician:
    Procedure:
    Consent for procedure agreed to by patient:
Back:
    Drug allergies None, Yes:
    Latex allergies None, Yes:
    OR Sign-in:
    OR Time-Out:
    OR Sign-Out:
```

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1a is a front view of a Tag Identification Card of the present invention; and

FIG. 1b is a rear view of a Tag Identification Card of the present invention.

### DETAILED DESCRIPTION OF THE INVENTION

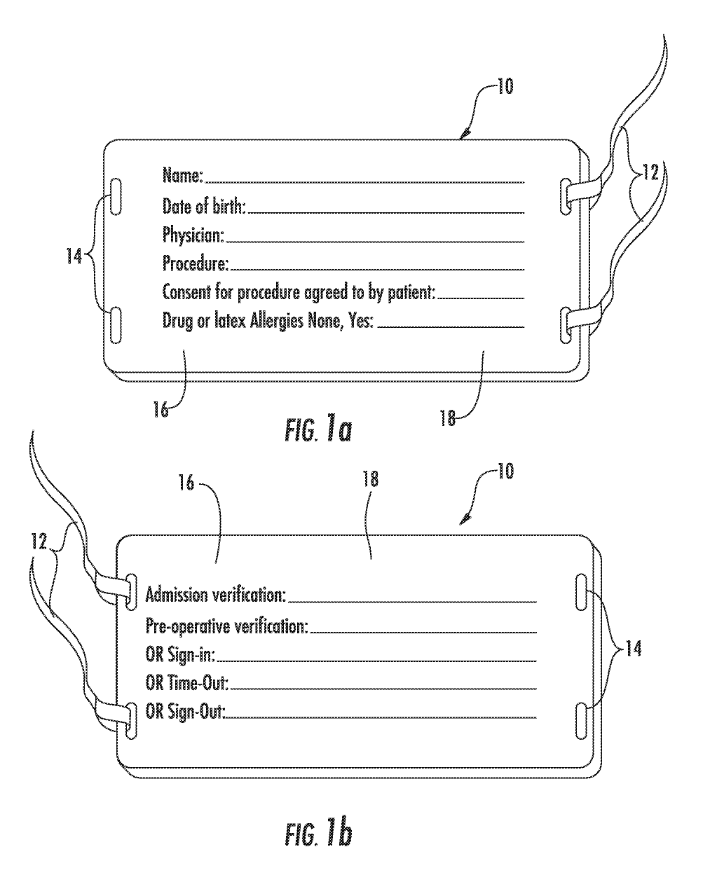

Now referring to the drawings, the tag identification (ID) card system of the present invention is shown and generally illustrated in FIGS. 1a and 1b. As can be seen the identification tag 10 shall be made of a non-irritating synthetic material. It shall be of similar size to a USA Hospital Addressograph plastic plate, preferably approximately 86 mm×55 mm or roughly “3⅜”×“2⅛”. This Tag ID Card 10 shall have pre-attached straps 12 or a hole or holes 14 for threading a strap device 12 allowing the Tag ID Card 10 to pre-operatively attached to the patient's extremity. Preferably the Tag ID Card is attached to an arm or leg of the patient and more preferably to the arm, as it is likely to be in view of the anesthesiologist and therefore, increase the likelihood of being completed. If there are no extremities, it may be placed or hung around the patient's neck.

The Tag ID Card 10 shall have pre-printed information 16 that includes: name, date of birth, physician, procedure, consent for procedure by patient, drug allergies, latex allergies, sign-in, time-out and sign-out. The Tag ID Card 10 shall have a lined area 18 that allows the physician, patient and hospital staff to complete and sign when the check lists has been completed. This information shall be placed on both sides of the Tag ID Card 10. Such information may be preferably arranged as follows:

```
Front:
    Name:
    Date of Birth:
    Physician:
    Procedure:
    Consent for procedure agreed to by patient:
    Drug or latex allergies None, Yes:
Back:
    Admission verification:
    Pre-operative verification:
    OR Sign-in:
    OR Time-Out:
    OR Sign-Out:
```

The Pre-printed information 16 shall be of a permanent printed material embedded on the synthetic Tag ID card 10. The printed information recorded by the patient, physician and OR staff shall utilize a non-irritating indelible marker. To ensure survival of the pre-hospital patient scribed information, a clear coat shall be overwritten on the recorded information. This will help to ensure the information survives bathing and rubbing on clothing. The staff shall use the same clear coat following their signatures.

In operation, the Tag Identification Card 10 system is first activated by the Surgeon and Patient once the surgical procedure has been agreed to. A non-irritating tag 10 is utilized for the Surgeon and Patient to sign acknowledging the agreed procedure. The Tag ID Card 10 may then be attached to the patient's leg on the same side as the surgical procedure or may be placed by the patient prior to arriving for the procedure.

When the patient arrives to the facility the site may be verified with the patient, the staff will sign the Tag ID Card 10. When the patient arrives to the Pre-operative holding unit and the site is again verified, the staff will again sign the Tag ID Card 10. In the Operatory or Procedure Room, the procedure is again verified by the OR staff and the tag is again signed. Once the procedure is complete, the Tag ID Card 10 may be removed and entered into the chart or scanned in electronically.

It can be seen that the system of the present invention eliminates the chance of a Wrong Site or Wrong Patient Surgery, eliminates the need to report Wrong Site or Wrong Patient Surgery to the State, to Federal Agencies or Insurance companies, eliminates Wrong Site or Wrong Patient Surgery legal suits, eliminates the harm to the Patient and Families for Wrong Site or Wrong Patient Surgery and eliminates the hassles of finding the written consent that are often misplaced during the pre-operative period. As a result, the system is a near fail-safe way for a patient to ensure the proper surgical procedure is performed and complies with JCAHO and WHO guidelines for Wrong Site Surgery. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A Tag Identification Card system for implementing a uniform standard of care for a patient undergoing a medical or surgical procedure, comprising:
a tag having a front surface and a back surface;
preprinted indicia on said front and back surfaces relating to items on a surgical safety checklist;
lines adjacent said indicia configured to receive handwritten indicia for confirmation that each of said items on said surgical safety checklist are completed; and
means for affixing said tag to said patient undergoing a medical or surgical procedure,
wherein said tag is first activated once said surgical procedure has been agreed to, said tag being attached to the patient, said tag being verified and signed upon patient arrival, during Pre-operative holding and in the Procedure Room.

2. The system of claim 1, wherein said tag is formed from a non-irritating synthetic material.

3. The system of claim 1, wherein said tag is of similar size to a USA Hospital Addressograph plastic plate.

4. The system of claim 1, wherein said tag is approximately 86 mm×55 mm.

5. The system of claim 1, wherein a protective clear coat is applied over said preprinted indicia.

6. The system of claim 1, wherein a protective clear coat is applied over said handwritten indicia as it is placed on said tag.

7. The system of claim 1, wherein said means for affixing said tag to said patient undergoing a medical or surgical procedure further comprises holes in said tag.

8. The system of claim 7, wherein said means for affixing said tag to said patient undergoing a medical or surgical procedure further comprises straps extending through said holes in said tag.

9. The system of claim 8, wherein said straps are used to affix said tag said patient's extremities.

10. The system of claim 8, wherein said straps are used to hang said tag about said patient's neck.
